(19) United States
(12) Patent Application Publication
(10) Pub. No.: US 2016/0358002 A1
(43) Pub. Date: Dec. 8, 2016

(54) INTERACTIVE METHOD FOR COMMUNICATION OF MOBILE DEVICE AND STORAGE CONTAINERS

(71) Applicant: Marco Antonio PEREIRA DA SILVA, Sao Paulo (BR)

(72) Inventor: Nair RODRIGUES BRAIDOTTI, Sao Paulo (BR)

(21) Appl. No.: 14/976,380

(22) Filed: Dec. 21, 2015

(30) Foreign Application Priority Data
Jun. 3, 2015 (BR) 10 2015 013082 1

(51) Int. Cl. G06K 7/14

(52) U.S. Cl. CPC G06K 7/1417

(57) ABSTRACT

The present invention refers to an interactive method for communication of a mobile device and storage containers, particularly for storing objects, food products, pharmaceutical products, among others, which provides the perfect storage control. More specifically, the present invention refers to an interactive method between communication mobile device and storage containers via barcode in two dimensions (QR Code). The present invention also refers to a communication system for controlling the plastic containers content, containers manufactured in plastic material, as well as their uses.

### FIELD OF THE INVENTION

The present invention refers to an interactive method for communication of a mobile device and storage containers, the containers being particularly for storing objects, food products, pharmaceutical products, among others, which provides the perfect storage control of their contents. More specifically, the present invention refers to an interactive method for communication of a mobile device and storage containers through a barcode in two dimensions , such as a QR Code.

The present invention also refers to communication system for controlling plastic containers contents, a container manufactured in plastic material, as well as their uses.

### BACKGROUND OF THE INVENTION

Times ago the control and the organization of objects and products is performed using containers, generally boxes and pots with labels of identification glued thereof and, repeatedly, is the organizer memory having the function of reminding where put every object or product with the labels help. Even in the small companies, this principle and method of control and organization is also currently employed. The stock manager, for example, makes its management manually, in a notebook or in a computer sheet, but in a static way, without alerts, fast research, or other auxiliary mean. Therefore, it is needed to provide a mean by which the control and the organization of small objects and products stored in containers are performed in an interactive way, providing quickness and safety when identifying the object or product stored.

“QR Code” or Quick Response Code—is a barcode in two dimensions, was created in 1994, and have ability to be quickly interpreted by people. The “QR code” became popular due to its ability of storing greater amount of information in a small printed space in a label, which may be quickly read with acuteness and transmitted with several uses perspectives.

“QR code” has been used for several industries in the products identification, in magazines, advertisements, visit cards, etc., being the code used to store URLS that after are guided to a website, hotsite, video, etc. “QR code” may also be easily scanned by any update cellphone (smartphone), where there are specific applications having the capacity to read the link and take the client in potential for the website the company wants. There are several applications available on the Internet specific for reading “QR code” and almost all update cellphones may download. Thus, the use of “QR code” became popular together with the use of the Internet in cellphones, reason for the companies view an interesting strategy of market for this type of public, generally composed of teenagers. The idea of the “QR code” kept up to now is take the client to a website, or then bring texts with the product information, curiosities, etc., but always under the conditions predetermined by the “QR code” manufacturer.

Among various patent documents of the prior art describing applications with the use of QR code US2012/0085828, US2014/0224702, US2015/0121625, WO2013116110, JP2014164534 may be mentioned, however, it is not known, to date, about applications for providing fast and efficient control and organization of objects and products stored in containers and that is established by the user itself through an application specifically developed for this purpose.

### SUMMARY OF THE INVENTION

It is, therefore, an object of the present invention to provide an interactive method for communication of a mobile device and storage containers of industrial or personal objects, which provides the perfect identification and storage control. More specifically, the present invention refers to the interactive method between communication mobile device and storage containers using barcode in two dimensions (“QR Code”), wherein said interaction may be established according to the parameters determined by the user itself.

It is also the object of the present invention to provide a communication system for controlling plastic containers content.

Another object of the present invention is to provide containers manufactured in plastic material allowing the interactive method according to the present invention.

In addition, the object of the present invention is the use of a communication system for storage control of small objects and utensils, food products, pharmaceutical products, among others, in a way they may be fast identified and recovered from the storage container.

### BRIEF DESCRIPTION OF THE DRAWINGS

The present method of communication in accordance with the present invention can be understand by the drawings attached herewith, which illustrate a non-limitative example of embodiment of the invention.

FIG. 1 is a flowchart of the method according to the present invention.

FIG. 2 is an illustration of the communication system for controlling the plastic container content according to the present invention.

FIG. 3 is an example of the plastic container used for allowing the interactive system according to the present invention.

### DETAILED DESCRIPTION OF THE INVENTION

The objects aforementioned are achieved through the interactive method between communication mobile device and storage containers object of the present invention, which comprises the basic steps of (i) download specific application for reading QR code, (ii) present orientation for inserting data in the application, (iii) identify the container through its QR code, (iv) feed the application with data about the container localization environment, (v) feed the application with identification data of the items stored in the said container, (vi) recover information about a specific item stored in the container by inserting the identification of the stored item, or (iv) recover information about the items stored through the QR code reader.

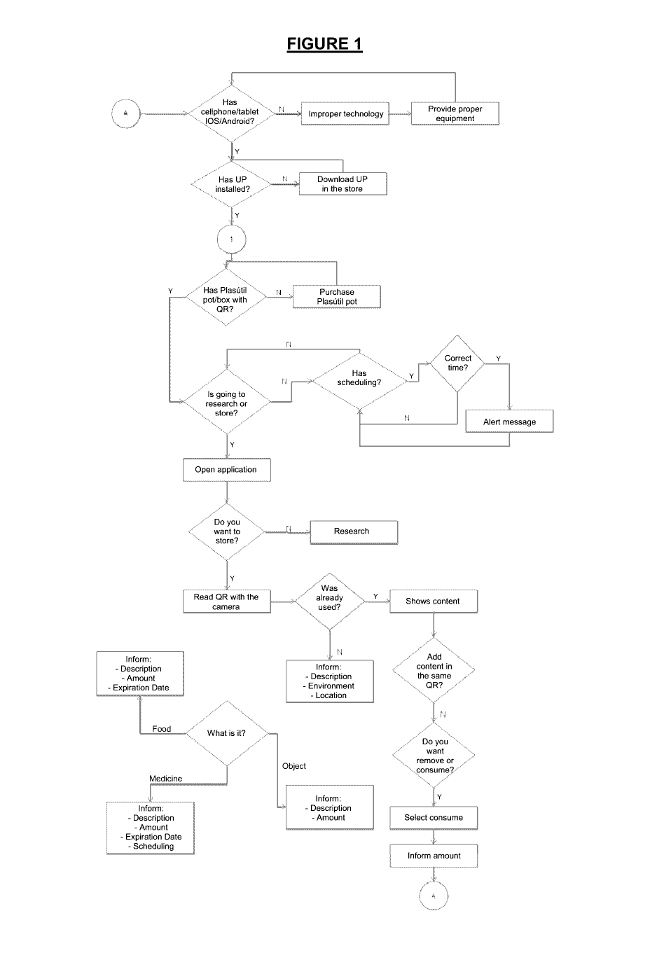

More specifically, the interactive method between the communication mobile device and storage containers object of the present invention may be implemented as illustrated in the flowchart of the FIG. 1. Accordingly, it is noted that the user (A) must have a communication device (cellphone or tablet) provided with IOS or Android system. If not, he/she must purchase a device proper for making the method work according to the present invention. If yes, the device must download the application called “UP PLASÚTIL” available by the store, which will be used with the container, generally as pot or box, provided with QR code. With the mobile device camera, the QR code is read and then are fed information describing the product item, the amount, the environment and the place where the container is found, and the user may insert a photo of each item that wants to register. In this way, when searched through the QR code the application UP PLASÚTIL will display the content of the container from where one or more items may be removed or consumed, informing the removed amount. In this way, the user A will have the updated information about the container content.

Cases wherein the container was not registered by the application UP PLASÚTIL will be automatically displayed orientation for its registering. Once registered the container, the application UP PLASÚTIL will read the QR code and will display the items stored therein, offering options for adding new items or removing those existent in the container.

It must be noted that in certain applications, for example, the storage of drugs, the application UP PLASÚTIL according to the method according to the present invention allows scheduling with hour and message of alert for consumption. In this case, the application UP PLASÚTIL allows registering the description, amount, expiration date and the scheduling consisting of informing the name of who will receive the medication, the start date of the drug administration, the time, the frequency, this measure per hours or days or weeks, and each administration dose. Also in this scheduling a note field is found for guiding the user of the application UP PLASÚTIL to insert any information, as for example, take the medication fasting.

In others applications, as in the case of storage of food products, the application UP according to the method of the present invention allows registering the description, amount and expiration date deadline.

Example of the items register display may be as follows:
Name of the numbered box/Environment/Local/Content type to be stored (things/foods/drugs)
Information of the content: name/amount/expiration date.

The search of items may be performed through the menu “My Environments”, registered and subdivided by the locations, as follows:
My Environments/Kitchen/Freezer/(containers+content)

In addition, in the case of medications, for example, the interactive method according to the present invention will provide an option of reminders, with scheduling pre-established by the user itself with data of when and how much it must be medicated of each drug. These reminders are automatically triggered by the application UP PLASÚTIL in the user mobile device.

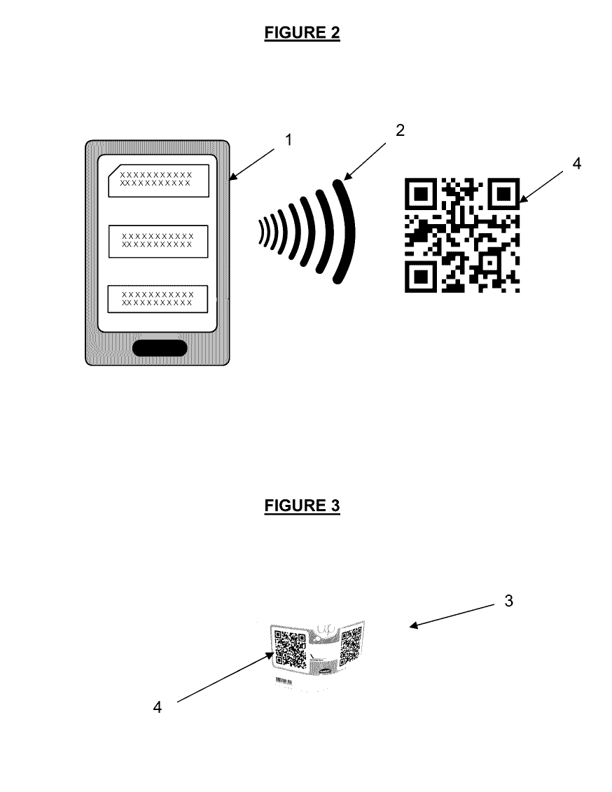

The present invention also refers to a communication system for controlling plastic containers content using the interactive method described above, as illustrated in the FIGS. 2 and 3. In these, it is verified that the interactive system according to the present invention comprises a communication mobile device (1), such as a “smartphone” or “tablet”, that must have digital camera, the reading application of QR code according to the method according to the present invention interacting (2) one label with QR code (4) provided with a container.

The QR code (4) is single, permanent and inviolable, being for this purpose, preferably installed by intraimage labeling process in containers manufactured in injection-molded plastic material. Preferably, said label with QR code is installed in the plastic container by intraimage labeling process. Most preferably, the intraimage labeling process is that one of the patent BR/P10105663-8. Thus, each container will have a “DNA”, being, therefore, individualized, distinct and easy identification and location.

The FIG. 3 illustrates a plastic container (3) model provided with label having QR code (4) according to the present invention, installed by intraimage process. Preferably, the installation process of the label having QR code (4) comprises the application of a variable static electricity charge between 2 to 28 kilovolts in the label with QR code (4), placement of said label with QR code (4) charged inside the injection mold (not shown), maintenance of said label with QR code (4) charged inside the said mold while proceeding with the plastic injection. Particularly, this process avoids drawbacks that could be caused by excess or lack of static electricity charge in the label with QR code (4) during the installation process of the label in the plastic container (3).

As can be seen, the method and the interactive system according to the present invention, has various uses and practical applications for organization, identification, and recovery of items stored in containers, particularly in plastic containers, providing, in some cases, control of the use in the amount, expiration date, and consumption form of products.

The interactive system according to the present invention allows opening specific displays for feeding data and photos of the contents to be stored, allowing the data management, such as inputs, outputs, expiration dates, searches, and alerts.

The system according to the present invention memorizes everything organized and may also trigger alerts informing medication times, the expiration date of foods. However, the main function of the method and interactive system according to the present invention is to provide means so that the user finds what was stored, easily, efficiently, and in an interactive manner.

For example, but not limiting to these uses, the present invention may be used for controlling the objects storage, such as tools, seasonal decorations (Christmas, Easter), utensils (special dates), rarely used clothes (winter), documents, books, collections, sporadic use toys, souvenirs, photographs, sporting or leisure material, shoes, etc. It can also be used to control the storage of foods, such as for freezing, in the refrigerator and in the pantry. It can also be used to store and organize drugs, separating them by day of the week, by function and contributing to the remembrance of their therapy. It can also be used to control stocks of all kinds in small businesses such as cafeterias, food truck, selling clothes, tools, etc.

The registration by the system of a container and of the items stored therein thus allows a quick search, as opposed to a static list that must be run to identify the item you want. Another function is the control of the expiration date, it is possible to pre-set in advance alerts regarding the maturity of a product. So, the information of when the expiration date of a product will be ending becomes active and not passive as currently occurs. As agenda for medication, other than currently practiced, besides remembering the stipulated time, automatically the stock management of a dose less is performed, if it occurs, alerting the user the amount of stock of each drug.

Thus, as can be seen by the people skilled in the art, the method and interactive system between communication mobile device and storage containers object of the present invention might have other uses and applications that, although not specifically mentioned, are herein incorporated as reference.

1. AN INTERACTIVE METHOD FOR COMMUNICATION OF A MOBILE DEVICE AND STORAGE CONTAINERS, by using of QR code, the method comprises the basic steps of (i) download specific application for reading de QR code, (ii) present orientation for inserting data in the application, (iii) identify the container through its QR code, (iv) feed the application with data about the container localization environment, (v) feed the application with identification data of the items stored in the said container, (vi) recover information about a specific item stored in the container by inserting the identification of the stored item, or (iv) recover information about the items stored through the QR code reader.

2. THE METHOD, according to claim 1, wherein if a container was not registered the application will display orientation for its registering.

3. THE METHOD, according to claim 1, wherein said application after reading the QR code displays the items stored therein, offering options for the user itself add new items or remove those stored in the container.

4. THE METHOD, according to claim 1, wherein it displays the items registration as the following:
Name of the numbered box/Environment/Local/Content type to be stored (things/foods/drugs)
Content information: name/amount/expiration date.

5. THE METHOD, according to claim 1, wherein the items search is performed through the menu “My Environments”, registered and subdivided by the locations, as follows:
My Environments/Kitchen/Freezer/(containers+content)

6. THE METHOD, according to claim 1, wherein it provides the option of reminders with scheduling of the pre-established consumption by the user itself, which will be automatically triggered by the application.

7. THE METHOD, according to any of the claim 1, wherein the stored and controlled item is an article, a product, a food product or a drug.

8. A COMMUNICATION SYSTEM FOR CONTROLLING PLASTIC CONTAINER CONTENTS, comprising a communication mobile device (1), the reading application of QR code according to the method defined claim 1, interacting with a container (3) provided with a label containing the QR code (4).

9. THE SYSTEM, according to claim 8, wherein the mobile device is a smartphone or table provided with digital camera.

10. The system according to claim 8, wherein after identifying the container by the mobile device through QR code (4), allows the user itself inserting or removing items from the list of objects or products stored in the container.

11. THE SYSTEM, according to claim 8, wherein the QR code (4) is single, permanent and inviolable.

12. A PLASTIC CONTAINER, for using in the system defined in claim 8, wherein the plastic container is manufactured by plastic injection and has a label with QR code installed by interimage labeling process.

13. THE PLASTIC CONTAINER, according to claim 12, wherein the interimage labeling process comprises the application of a variable static electricity charge between 2 to 28 kilovolts in the label with QR code (4), placement of the said label with QR code (4) charged inside an injection mold, maintenance of the said label with QR code (4) charged inside the said mold while the plastic injection takes place to form the container (3).
